(19) United States
(12) Patent Application Publication
(10) Pub. No.: US 2025/0130788 A1
(43) Pub. Date: Apr. 24, 2025

(54) UPDATE APPARATUS

(71) Applicant: SUBARU CORPORATION, Tokyo (JP)

(72) Inventors: Shinichiro NAKAHIRA, Tokyo (JP); Yasuji YAMAGISHI, Tokyo (JP); Daisuke KATO, Tokyo (JP); Koki ANDO, Tokyo (JP); Naoto MOURI, Tokyo (JP); Kaoru SHIZUNO, Tokyo (JP)

(21) Appl. No.: 18/909,182

(22) Filed: Oct. 8, 2024

(30) Foreign Application Priority Data
Oct. 18, 2023 (JP) 2023-179843

(51) Int. Cl. G06F 8/65; B60W 50/14; G07C 9/00

(52) U.S. Cl. CPC G06F 8/65; B60W 50/14; G07C 9/00; B60W 2050/146

(57) ABSTRACT

An update apparatus includes a vehicle detection unit that detects entrance of a vehicle into a specific area which the vehicle can enter, a control unit, a notification unit, and a communication unit that establishes communication between the control unit and the vehicle. The control unit includes at least one processor and at least one memory connected to the processor. The processor performs a process including: performing, in response to detection of entrance of the vehicle into the specific area, certain presentation indicating characteristics of the vehicle after update to update at least part of data and programs concerning control of the vehicle is performed to notify an occupant of the vehicle of the presentation via the notification unit; and transmitting update information indicating content of the update to the vehicle via the communication unit after the presentation is indicated to cause the vehicle to perform the update.

### CROSS-REFERENCE TO RELATED APPLICATIONS

The present application claims priority from Japanese Patent Application No. 2023-179843 filed on Oct. 18,2023, the entire contents of which are hereby incorporated by reference.

### BACKGROUND

The disclosure relates to an update apparatus that updates software of a vehicle.

For example, Japanese Unexamined Patent Application Publication (JP-A) No. 6-328981 discloses a control gain modification apparatus that modifies control gain of a control unit of a vehicle. In JP-A No. 6-328981, the control gain is wirelessly transmitted from a portable gain modifier to the gain modification apparatus provided in the vehicle to modify characteristics of a driving system and so on of the vehicle based on the received control gain.

### SUMMARY

An aspect of the disclosure provides an update apparatus. The update apparatus includes a vehicle detection unit, a control unit, a notification unit, and a communication unit. The vehicle detection unit is configured to detect entrance of a vehicle into a specific area which the vehicle can enter. The communication unit is configured to establish communication between the control unit and the vehicle. The control unit comprises at least one processor and at least one memory connected to the at least one processor. The at least one processor performs a process including: performing, in response to detection of the entrance of the vehicle into the specific area, certain presentation indicating characteristics of the vehicle after update to update at least part of data and programs concerning control of the vehicle is performed to perform a notification of the presentation to an occupant of the vehicle via the notification unit; and performing a transmission of update information indicating content of the update to the vehicle via the communication unit after the presentation is indicated to cause the vehicle to perform the update.

An aspect of the disclosure provides an update apparatus. The update apparatus includes at least one processor, and at least one memory connected to the at least one processor. The at least one processor is configured to detect entrance of a vehicle into a specific area which the vehicle can enter and cause a communication unit to establish communication with the vehicle. The at least one processor performs a process comprising performing, in response to detection of the entrance of the vehicle into the specific area, certain presentation indicating characteristics of the vehicle after update to update at least part of data and programs concerning control of the vehicle is performed, to notify an occupant of the vehicle of the presentation via a notification unit, and transmitting update information indicating content of the update to the vehicle via the communication unit after the presentation is indicated to cause the vehicle to perform the update.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic block diagram illustrating the configuration of an update apparatus according to an embodiment;

FIG. 2 is a diagram illustrating an example of an update list indicating selectable updates;

FIG. 3 is a diagram illustrating an example of a parameter list indicating modifiable parameters;

FIG. 4 is a flowchart describing an operational flow in an update processor; and

FIG. 5 is a flowchart describing an operational flow in a vehicle controller.

### DETAILED DESCRIPTION

However, since the operation to modify the characteristics of a vehicle as disclosed in JP-A No. 6-328981, that is, the operation to update software of a vehicle, lacks entertainment and it is difficult to imagine how the characteristics of the vehicle are varied after the update, the motivation for the update is low in such an operation.

It is desirable to provide an update apparatus capable of improving the motivation for the update.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

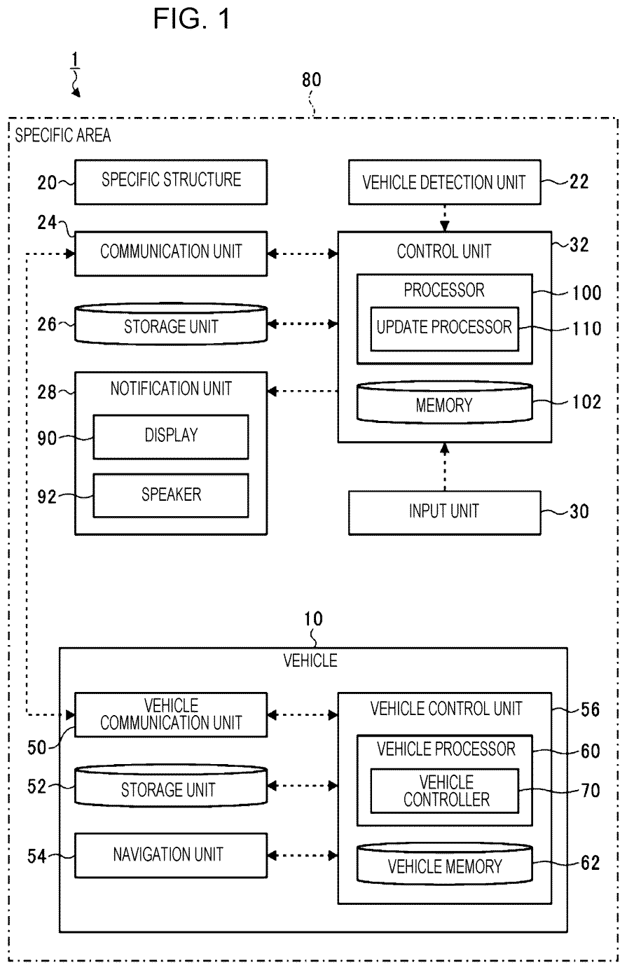

FIG. 1 is a schematic block diagram illustrating the configuration of an update apparatus 1 according to the embodiment. The update apparatus 1 realizes update to update at least part of data and programs concerning control of a vehicle 10. Such update of the vehicle 10 may be simply hereinafter referred to as update. In response to the update of the vehicle 10, the content of control concerning driving is modified to modify characteristics of the vehicle 10.

The vehicle 10 is an automobile that performs at least control concerning the driving with dedicated software. The software here is not limited to programs and may include data used in the programs. The vehicle 10 is, for example, an electric automobile including a motor generator as a driving source. The vehicle 10 may be a hybrid electric vehicle including the motor generator and an engine as the driving sources or may be an engine vehicle including the engine as the driving source.

The vehicle 10 includes a vehicle communication unit 50, a storage unit 52, a navigation unit 54, and a vehicle control unit 56.

The vehicle communication unit 50 is capable of establishing communication with a communication apparatus outside the vehicle 10 via a communication network, such as the Internet. The storage unit 52 is composed of a non-volatile storage device. The non-volatile storage device may include an electrically rewritable non-volatile storage device or the like, such as a flash memory.

The navigation unit 54 is capable of identifying the position of the vehicle 10 using a global positioning system (GPS). The navigation unit 54 is capable of deriving a driving route of the vehicle 10 based on map information, destination information, positional information about the vehicle 10, and so on. The navigation unit 54 includes a display capable of displaying a variety of information, such as the map information, the positional information about the vehicle 10, and information about the driving route. The navigation unit 54 includes a speaker capable of guiding information, such as lane change on the driving route, with sound. The navigation unit 54 includes an input unit, such as a touch panel, disposed on the screen of the display.

The vehicle control unit 56 includes a vehicle processor 60 as one or more processors and a vehicle memory 62 as one or more memories connected to the vehicle processor 60. The vehicle memory 62 includes a read only memory (ROM) in which programs and so on are stored and a random access memory (RAM) serving as a working memory. The vehicle processor 60 controls the entire vehicle 10 in cooperation with the programs included in the vehicle memory 62. The vehicle processor 60 executes the programs to serve as a vehicle controller 70 in one embodiment of the disclosure. The vehicle controller 70 performs various processes at least concerning the driving of the vehicle 10.

In the update apparatus 1, the update of the vehicle 10 is available at a timing desired by an occupant (occupants) (hereinafter simply referred to as an occupant) of the vehicle 10, which will be described below. Accordingly, the characteristics of the vehicle 10 are capable of being modified at the timing desired by the occupant of the vehicle 10 in the update apparatus 1. In addition, in the update apparatus 1, the update of the content desired by the occupant of the vehicle 10 is available, which will be described below. Accordingly, the characteristics of the vehicle 10 are capable of being modified into the content desired by the occupant of the vehicle 10 in the update apparatus 1. Furthermore, in the update apparatus 1, certain presentation indicating the characteristics of the vehicle 10 after the update is made before the update is performed. The certain presentation will be described below. Accordingly, since the occupant of the vehicle 10 is capable of experiencing the presentation in the update apparatus 1, it is possible to improve motivation for the update.

The update apparatus 1 includes a specific structure 20, a vehicle detection unit 22, a communication unit 24, a storage unit 26, a notification unit 28, an input unit 30, and a control unit 32.

A specific area 80 which the vehicle 10 can enter is set in the update apparatus 1. The specific area 80 is capable of being set to any position, such as a service station capable of charging an in-vehicle battery that supplies electric power to the motor generator of the vehicle 10, a sightseeing spot in each geographical area, and an event site. The specific area 80 has a size at least accommodating the vehicle 10 that enters and stops. The specific area 80 may not be separated by a structure, such as a fence. The specific area 80 may be set by, for example, a range in which the vehicle detection unit 22 described below is capable of detecting the vehicle 10.

The vehicle detection unit 22 has a configuration capable of detecting the entrance of the vehicle 10 into the specific area 80. The vehicle detection unit 22 may detect the entrance of the vehicle 10 in a non-contact manner, for example, with infrared radiation. The vehicle detection unit 22 may include, for example, a physical gate placed at the entrance of the specific area 80. In this case, the gate may be opened and the entrance of the vehicle 10 may be detected in response to a certain operation by the occupant of the vehicle 10 who has reached the closed gate with the vehicle detection unit 22.

The specific structure 20 is placed in the specific area 80. The specific structure 20 is built so as to surround the vehicle 10 entering the specific area 80. For example, the specific structure 20 may be formed in a tunnel shape through which the vehicle 10 is capable of passing. The specific structure 20 is not limitedly formed in the tunnel shape and, for example, may be formed in a frame shape, such as an automatic car washing machine placed in the service station or the like. The specific structure 20 is not limited to the aspect in which the specific structure 20 is built so as to surround the vehicle 10 and may be placed along a side face of the vehicle 10 stopped in the specific area 80, like a gate apparatus in a paid parking lot.

The communication unit 24 is capable of exchanging a signal and information with the control unit 32 described below. Communication between the control unit 32 and the vehicle communication unit 50 in the vehicle 10 is capable of being established via the communication unit 24. The storage unit 26 is composed of a non-volatile storage device. The non-volatile storage device may include an electrically rewritable non-volatile storage device or the like, such as a flash memory.

The notification unit 28 includes a display 90 and a speaker 92. The display 90 and the speaker 92 are provided, for example, in the specific structure 20.

For example, when the specific structure 20 is built so as to surround the vehicle 10, the display 90 is provided at a position which is on an inner side opposed to the vehicle 10 of the specific structure 20 and at which the occupant of the vehicle 10 is capable of visually recognizing the screen of the display 90 from the inside of the vehicle 10. When the specific structure 20 is placed along the side face of the vehicle 10, the display 90 may be provided at a position which is along the side face of the vehicle 10 and at which the occupant of the vehicle 10 is capable of visually recognizing the screen of the display 90 from the inside of the vehicle 10. The display 90 visually notifies the occupant of the vehicle 10 of various images and a variety of information.

The speaker 92 is provided at a position which is outside the vehicle 10 entering the specific area 80 and at which the occupant of the vehicle 10 is capable of hearing a sound from the speaker 92 from the inside of the vehicle 10. The speaker 92 auditorily notifies the occupant of the vehicle 10 of various sounds.

The input unit 30 is, for example, a touch panel disposed over at least part of the screen of the display 90. The input unit 30 is not limited to the touch panel and may be a physical switch, a keyboard, a mouse, and/or the like. The input unit 30 accepts various input operations by the occupant of the vehicle 10 or the like.

The control unit 32 includes one or more processors 100 and one or more memories 102 connected to the one or more processors 100. The memory 102 includes a ROM in which programs and so on are stored and a RAM serving as a working memory. The processor 100 serves as an update processor 110 in cooperation with the programs included in the memory 102 in one embodiment of the disclosure.

Here, the occupant of the vehicle 10 moves the vehicle 10 into the specific area 80 and stops the vehicle 10 in the specific area 80 when the occupant of the vehicle 10 asks for the update of the vehicle 10 by the update apparatus 1.

The update processor 110 performs the certain presentation indicating the characteristics of the vehicle 10 after the update, before the update of the vehicle 10 is performed, in response to detection of the entrance of the vehicle 10 into the specific area 80 to notify the occupant of the vehicle 10 of the presentation via the notification unit 28. The certain presentation will be described in detail below.

The update processor 110 transmits update information indicating the content of the update to the vehicle 10 via the communication unit 24 at any timing after the notification of the presentation to cause the vehicle 10 to perform the update based on the update information. The update is performed in the specific area 80. After the update is completed, the occupant of the vehicle 10 moves the vehicle 10 out of the specific area 80.

Here, most part of the update information used to modify the characteristics of the vehicle 10 is aggregate of data indicating the settings of various parameters, which indicate the characteristics of the vehicle 10. Accordingly, the volume of the update information is lower than that of information in re-programming of the vehicle 10. Consequently, in the update apparatus 1, it is possible to make the time involved in the transmission of the update information to the vehicle 10 and the time involved in the update in the vehicle 10 shorter than those in the re-programming.

In addition, in the update apparatus 1, multiple update options having different characteristics of the vehicle 10 may be prepared. The presentation and the update information are also prepared for each update option in the update apparatus 1. The multiple update options and the presentation and the update information for each update option are stored in the storage unit 26.

The update processor 110 performs a process to cause the occupant of the vehicle 10 to select one update from multiple update candidates, before the update of the vehicle 10 is performed, in response to detection of the entrance of the vehicle 10 into the specific area 80.

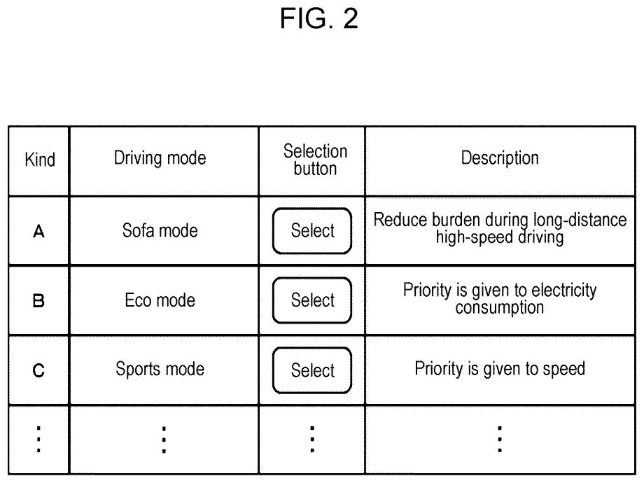

FIG. 2 is a diagram illustrating an example of an update list indicating selectable updates. The update list is displayed at a position close to a driving seat of the vehicle 10 on the screen displayed in the display 90. Since the screen displayed in the display 90 is wide, a frame indicating the screen is omitted in FIG. 2. The update list may be displayed in the navigation unit 54. In the example in FIG. 2, the update candidates include Update “A”, Update “B”, and Update “C”.

In Update “A”, a driving mode indicating the characteristics of the vehicle 10 is set to a “Sofa mode”. In the “Sofa mode”, the vehicle 10 has characteristics in which the burden during long-distance high-speed driving is capable of being reduced. For example, the characteristics of the vehicle 10 in the “Sofa mode” include a characteristic in which a driving sound is set to be lowered and a characteristic in which vibration of the vehicle 10 is suppressed. For example, in the “Sofa mode”, a carrier frequency in inverter control of the motor generator is lowered, compared with those in the other driving modes, to lower the driving sound. In the “Sofa mode”, for example, the oil pressure of a damper is increased, compared with those in the other driving modes, to suppress the vibration.

In Update “B”, the driving mode is set to an “Eco mode”. In the “Eco mode”, the vehicle 10 has characteristics in which priority is given to electricity consumption. For example, in the “Eco mode”, an upper limit of voltage or an upper limit of torque in the inverter control of the motor generator is restricted, compared with those in the other driving modes, to suppress power consumption.

In Update “C”, the driving mode is set to a “Sports mode”. In the “Sports mode”, priority is given to speed. For example, in the “Sports mode”, the upper limit of the torque is increased, compared with those in the other driving modes, to create a state in which high speed or acceleration is likely to occur.

The number of the update candidates is not limited to the number described above and the update candidates of any number may be provided. The update candidates do not limitedly have the content exemplified here and may have any content. For example, the update of the driving mode, such as a “Reproduction mode of engine in xxx era” in which a driving feeling of the engine in the xxx era is reproduced, may be prepared as the candidate.

The occupant of the vehicle 10 is capable of selecting the update by tapping any of the images of selection buttons displayed as “Selection”, which corresponds to the respective updates. The input unit 30, such as the touch panel, accepts an input instructing the selection of the update.

The update list may be displayed on the screen of the display of the navigation unit 54. In this aspect, the update processor 110 transmits information indicating the update list to the vehicle 10 via the communication unit 24. The vehicle controller 70 displays the update list on the screen of the display of the navigation unit 54 based on the received information indicating the update list. Upon acquisition of an input instructing the selection of the update with the input unit of the navigation unit 54, the vehicle controller 70 transmits the information instructing the selection of the update to the control unit 32 via the vehicle communication unit 50.

The certain presentation described above will now be described. The certain presentation includes, for example, a video in which environment, such as scenery or landscape outside the vehicle while the vehicle 10 is driving, is visually displayed and with which the occupant of the vehicle 10 is capable of imaging the characteristics of the vehicle 10. In addition, the certain presentation includes a sound which auditorily notifies the driving sound of the vehicle 10 or environmental sound outside the vehicle while the vehicle 10 is driving and with which the occupant of the vehicle 10 is capable of imaging the characteristics of the vehicle 10. Although both the video and the sound are desirably indicated as the certain presentation, one of the video and the sound may be indicated as the certain presentation.

For example, in the update to the Sofa mode, an easygoing video or a video in which the vibration of the video is suppressed may be indicated and the sound in which the driving sound is reduced may be emitted, compared with those in the other driving modes.

For example, in the update to the Eco mode, a video in which the vehicle 10 is slowly driving in a refreshing forest may be indicated and the environmental sound that is rich with nature may be emitted, compared with those in the other driving modes.

For example, in the update to the Sports mode, a video in which the vehicle 10 is lightly driving on a mountain pass may be indicated and the sound in which the driving sound is increased may be emitted, compared with those in the other driving modes.

The specific content of the presentation is not limited to the ones exemplified here and the presentation may have any content enabling the occupant of the vehicle 10 to image the characteristics of the vehicle 10 after the update.

The update processor 110 displays the video indicating the certain presentation in the display 90 in the notification unit 28 to notify the occupant of the vehicle 10 of the video and emits the sound indicating the certain presentation from the speaker 92 in the notification unit 28 to notify the occupant of the vehicle 10 of the sound.

The navigation unit 54 in the vehicle 10 may be caused to serve as the notification unit indicating the presentation in one embodiment of the disclosure to indicate the presentation of the video with the display of the navigation unit 54 and indicate the presentation of the sound with the speaker of the navigation unit 54. In such an aspect, the update processor 110 transmits presentation information indicating the presentation corresponding to the selected update to the vehicle 10 via the communication unit 24. The vehicle controller 70 causes the navigation unit 54 to serve as the notification unit based on the received presentation information in one embodiment of the disclosure.

After indicating the presentation corresponding to the selected update, the update processor 110 transmits the update information corresponding to the selected update to the vehicle 10. In response to reception of the update information, the selected update is performed in the vehicle 10. As a result, the characteristics of the vehicle 10 are modified to the characteristics indicated by the driving mode of the selected update.

The aspect is described above in which one update is selected from the multiple update candidates. However, one update may be prepared. In this case, the update processor 110 may indicate the presentation corresponding to the one update in response to detection of the entrance of the vehicle 10 into the specific area 80 without the selection of the update. In this aspect, the update information corresponding to the one update may be transmitted to the vehicle 10 automatically or after any confirmation is performed, after the presentation is indicated, without the selection of the update, and the one update may be performed in the vehicle 10.

After one update is selected from the multiple update candidates, the update processor 110 may enable the occupant of the vehicle 10 to modify at least part of the parameters indicating the characteristics of the vehicle 10, which are identified by the selected update. The modification of the parameters indicating the characteristics of the vehicle 10, which are identified by the update, may be hereinafter referred to as detailed setting for convenience of description.

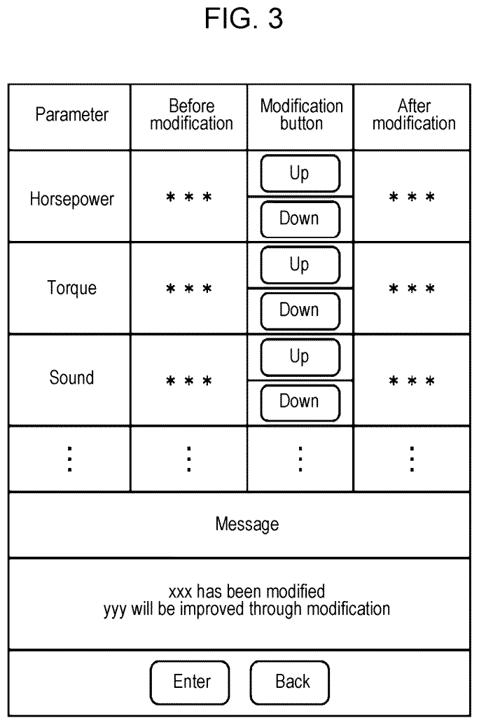

FIG. 3 is a diagram illustrating an example of a parameter list indicating modifiable parameters. The parameter list is displayed at a position closer to the driving seat of the vehicle 10 on the screen displayed in the display 90. Since the screen displayed in the display 90 is wide, the frame indicating the screen is omitted in FIG. 3. The parameter list may be displayed in the navigation unit 54.

FIG. 3 illustrates an example of the parameter list corresponding to Update “A” in which the driving mode is set to the Sofa mode. In the example in FIG. 3, the modifiable parameters include “Horsepower”, “Torque”, and “Sound”. A standard value indicating the characteristic of the vehicle 10 in the selected driving mode is set as an initial value for each parameter. A value that is varied depending on the content of the update, that is, depending on the driving mode is set as the initial value of the parameter. In other words, in the detailed setting using the parameter list, the parameters are capable of being fine-tuned from the initial values depending on the preference of the occupant of the vehicle 10.

The kinds of the modifiable parameters are not limited to the ones exemplified here and any parameters concerning the content of the selected update may be used. In addition, the modifiable parameters, that is, the parameter list may be varied depending on the update.

As illustrated in FIG. 3, a value before update, a modification button displayed as “Up”, a modification button displayed as “Down”, and a value after update are indicated for each parameter in the parameter list. For example, the initial value of the parameter is indicated as the value before update of each parameter.

In response to tapping of the modification button displayed as “Up” by the occupant of the vehicle 10, the value of the parameter corresponding to the modification button is increased and the increased value is displayed as the value after update of the parameter. In response to tapping of the modification button displayed as “Down” by the occupant of the vehicle 10, the value of the parameter corresponding to the modification button is decreased and the decreased value is displayed as the value after update of the parameter.

The content after update may be displayed as a message in response to tapping of the modification button “Up” or “Down” by the occupant of the vehicle 10.

In response to tapping of the modification button “Up” or “Down” by the occupant of the vehicle 10, the update processor 110 performs the presentation which corresponds to the selected update and in which the modification of the parameter by the occupant of the vehicle 10 is reflected to indicate the presentation with the notification unit 28.

For example, it is supposed that the update of the Sofa mode is selected, the presentation in the Sofa mode is indicated with the notification unit 28, and the occupant of the vehicle 10 experiences the presentation of the Sofa mode. It is supposed that the occupant of the vehicle 10 feels that the “Sound” is louder than the estimated sound as the result of the experience of the presentation. In this case, the occupant of the vehicle 10 taps the modification button “Down” of the “Sound” parameter.

In response to tapping of the modification button “Down” of the “Sound” parameter by the occupant of the vehicle 10, the update processor 110 decreases the parameter of the sound in the Sofa mode by one step. For example, the update processor 110 decreases the carrier frequency from the initial value in the Sofa mode by a certain value. Then, the update processor 110 performs the presentation after the “Sound” parameter is decreased to indicate the presentation with the notification unit 28. As a result, the occupant of the vehicle 10 is capable of experiencing and confirming the presentation in which the “Sound” parameter is decreased by one step.

When the occupant of the vehicle 10 agrees the characteristics of the vehicle 10 as the result of the experience of the presentation, the occupant of the vehicle 10 taps a determination button displayed as “Enter”. This determines the content of the update and the update processor 110 transmits the update information which corresponds to the selected update and in which the modification of the parameter by the occupant of the vehicle 10 is reflected to the vehicle 10. The selected update in which the modification of the parameter by the occupant of the vehicle 10 is reflected is performed in the vehicle 10. As a result, the characteristics of the vehicle 10 are modified to the characteristics which are indicated by the driving mode of the selected update and in which the modification of the parameters by the occupant of the vehicle 10 is reflected.

The occupant of the vehicle 10 is capable of personalizing the characteristics of the vehicle 10 in detail in the above manner.

When the occupant of the vehicle 10 feels that the characteristics of the vehicle 10 are different from the desired content of the update as the result of the experience of the presentation, the occupant of the vehicle 10 taps a back button displayed as “Back”. In response to the tapping of the back button displayed as “Back” by the occupant of the vehicle 10, the update processor 110 re-displays the update list. The occupant of the vehicle 10 is capable of re-selecting the update. The parameter may be returned to the state before “Down” or “Up” is tapped when the back button displayed as “Back” is tapped.

The parameter list may be displayed in the display of the navigation unit 54, like the update list. The function of the detailed setting for modifying the parameters may be omitted.

The update processor 110 may acquire information indicating the age of a driver who drives the vehicle 10, among the occupants of the vehicle 10. In this aspect, the update processor 110 may correct the initial value of each parameter in the driving mode of the selected update based on the acquired age. For example, when the acquired age belongs to younger ages and the update of the Sofa mode is selected, the update processor 110 may decrease the initial value of the “Sound” parameter in the Sofa mode in accordance with the acquired age. For example, when the acquired age belongs to older ages and the update of the Sofa mode is selected, the update processor 110 may increase the initial value of the “Sound” parameter in the Sofa mode in accordance with the acquired age.

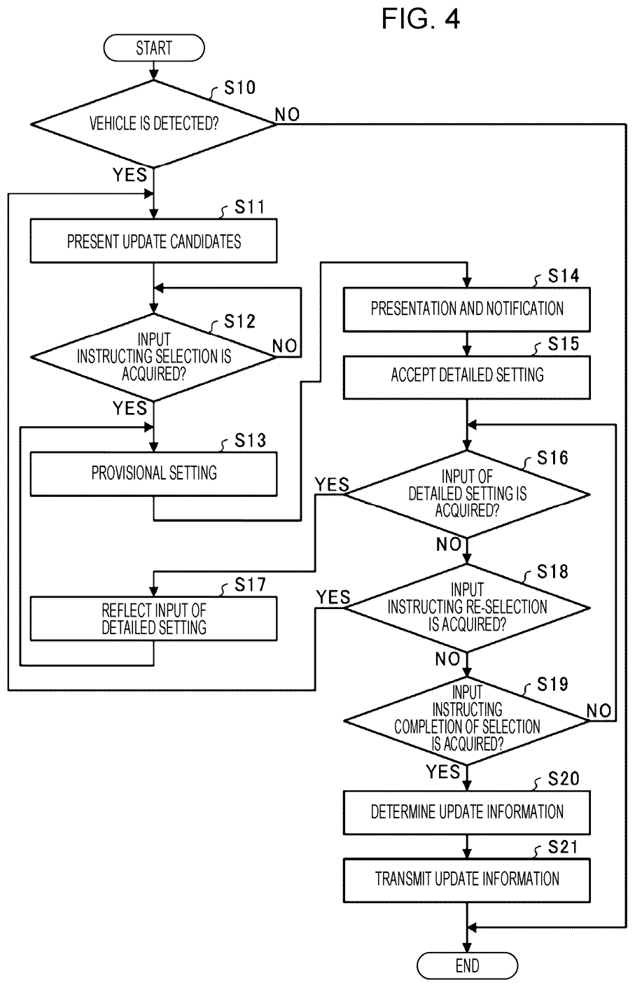

FIG. 4 is a flowchart describing an operational flow in the update processor 110. Referring to FIG. 4, in Step S10, the update processor 110 determines whether the vehicle 10 is detected by the vehicle detection unit 22. If the update processor 110 determines that the vehicle 10 is detected by the vehicle detection unit 22 (YES in Step S10), the update processor 110 perform Step S11 and the subsequent steps. If the update processor 110 determines that the vehicle 10 is not detected by the vehicle detection unit 22 (NO in Step S10), the update processor 110 is in a waiting state until the vehicle 10 is detected.

In Step S11, the update processor 110 presents the update candidates to the occupant of the vehicle 10. For example, the update processor 110 displays the update list illustrated in FIG. 2 on the screen of the display 90. This enables the occupant of the vehicle 10 to select the update.

In Step S12, the update processor 110 determines whether an input instructing the selection of the update is acquired with the input unit 30, such as the touch panel, on the screen of the display 90. If the update processor 110 determines that an input instructing the selection of the update is not acquired (NO in Step S12), the update processor 110 is in the waiting state until an input instructing the selection of the update is acquired. If the input instructing the selection of the update is not acquired even after a predetermined time, the update processor 110 may enforcedly select any update.

If the update processor 110 determines that an input instructing the selection of the update is acquired (YES in Step S12), in Step S13, the update processor 110 provisionally sets the content of the selected update as the content of the update to be performed.

In Step S14, the update processor 110 performs the presentation corresponding to the content of the update that is provisionally set to indicate the presentation with the notification unit 28.

In Step S15, the update processor 110 accepts the detailed setting along with the indication of the presentation. For example, the update processor 110 displays the parameter list illustrated in FIG. 3 on the screen of the display 90. This enables the occupant of the vehicle 10 to modify the parameter identified by the selected update.

In Step S16, the update processor 110 determines whether an input of the detailed setting for modifying the parameter is acquired with the input unit 30, such as the touch panel, on the screen of the display 90. For example, when the modification button “Up” or “Down” in the parameter list is tapped, the update processor 110 may determine that an input of the detailed setting is acquired.

If the update processor 110 determines that an input of the detailed setting is acquired (YES in Step S16), in Step S17, the update processor 110 reflects the modification of the parameter based on the input of the detailed setting. Then, in Step S13, the update processor 110 updates the provisional setting of the content of the update to be performed. In Step S14, the update processor 110 performs the presentation corresponding to the content of the update that is updated to indicate the presentation with the notification unit 28. Then, the update processor 110 repeats Step S15 and the subsequent steps.

If the update processor 110 determines that an input of the detailed setting is not acquired (NO in Step S16), in Step S18, the update processor 110 determines whether an input instructing re-selection of the update is acquired. For example, the update processor 110 may determine that an input instructing re-selection is acquired when the back button displayed as “Back” in the parameter list is tapped.

If the update processor 110 determines that an input instructing re-selection is acquired (YES in Step S18), in Step S11, the update processor 110 displays the update list on the screen of the display 90 to present the update candidates to the occupant of the vehicle 10. Then, the update processor 110 repeats Step S12 and the subsequent steps.

If the update processor 110 determines that an input instructing re-selection is not acquired (NO in Step S18), in Step S19, the update processor 110 determines whether an input instructing completion of the selection is acquired. For example, when the determination button displayed as “Enter” in the parameter list is tapped, the update processor 110 may determine that an input instructing completion of the selection is acquired.

If the update processor 110 determines that an input instructing completion of the selection is not acquired (NO in Step S19), the update processor 110 repeats Step S16 and the subsequent steps.

If the update processor 110 determines that an input instructing completion of the selection is acquired (YES in Step S19), in Step S20, the update processor 110 determines the content of the latest update provisionally set in Step S13 as the content of the update to be performed to determine the update information using the determined content of the update. In Step S21, the update processor 110 transmits the determined update information to the vehicle 10 with the communication unit 24. Then, the series of steps in FIG. 4 are terminated.

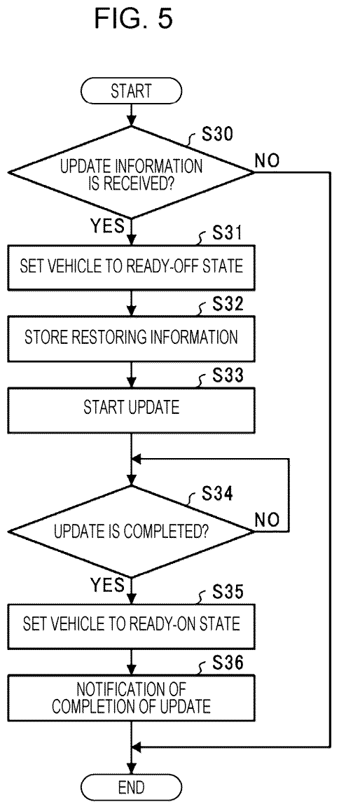

FIG. 5 is a flowchart describing an operational flow in the vehicle controller 70. Referring to FIG. 5, in Step S30, the vehicle controller 70 determines whether the update information is received from the control unit 32 via the communication unit 24. If the vehicle controller 70 determines that the update information is received from the control unit 32 via the communication unit 24 (YES in Step S30), the vehicle controller 70 performs Step S31 and the subsequent steps. If the vehicle controller 70 determines that the update information is not received (NO in Step S30), the vehicle controller 70 is the waiting state until the update information is received.

If the vehicle controller 70 determines that the update information is received (YES in Step S30), in Step S31, the vehicle controller 70 set the vehicle 10 to a ready-off state. In Step S32, the vehicle controller 70 stores a variety of information indicating the current characteristics of the vehicle 10 in the storage unit 52 as restoring information. The restoring information is stored to enable the characteristics of the vehicle 10 to be restored to the characteristics before the update is performed in preparation for any error that is found after the update is performed.

In Step S33, the vehicle controller 70 starts the update in accordance with the received update information. In Step S34, the vehicle controller 70 determines whether the update is completed. If the vehicle controller 70 determines that the update is not completed (NO in Step S34), the vehicle controller 70 is in the waiting state until the update is completed.

If the vehicle controller 70 determines that the update is completed (YES in Step S34), in Step S35, the vehicle controller 70 sets the vehicle 10 to a ready-on state. In Step S36, the vehicle controller 70 indicates that the update is completed with, for example, the display of the navigation unit 54. Then, the series of steps in FIG. 5 are terminated.

As described above, in the update apparatus 1 according to the present embodiment, certain presentation is performed, which indicates the characteristics of the vehicle 10 after the update, in response to detection of the entrance of the vehicle 10 into the specific area 80 to notify the occupant of the vehicle 10 of the presentation with the notification unit 28. In the update apparatus 1 of the present embodiment, the update information indicating the content of the update is transmitted to the vehicle 10 via the communication unit 24 after the notification of the presentation to cause the vehicle 10 to perform the update.

Accordingly, in the update apparatus 1 of the present embodiment, the occupant of the vehicle 10 is capable of experiencing the characteristics of the vehicle 10 after the update through the presentation before the update is performed. Consequently, in the update apparatus 1 according to the present embodiment, it is possible to improve the motivation for the update due to an element of attraction of experiencing the presentation.

In the update apparatus 1 according to the present embodiment, the presentation causes the feeling of the occupant of the vehicle 10 that the occupant of the vehicle 10 wants to experience the presentation. As a result, in the update apparatus 1 according to the present embodiment, the occupant of the vehicle 10 is capable of improving the motivation to go into the specific area 80. As a result, in the update apparatus 1 according to the present embodiment, it is possible to improve the motivation to perform the update.

In the update apparatus 1 according to the present embodiment, the element of the experience, such as sightseeing, is capable of being combined with the update, for example, by setting the specific area 80 at a sightseeing spot or the like, that is, by disposing the vehicle detection unit 22, the notification unit 28, and so on in a sightseeing spot or the like. As a result, in the update apparatus 1 according to the present embodiment, it is possible to improve the motivation for the update.

In the update apparatus 1 according to the present embodiment, the occupant of the vehicle 10 is capable of going to the specific area 80 to perform the update of the vehicle 10. Accordingly, in the update apparatus 1 according to the present embodiment, it is possible to perform the update of the vehicle 10 at a timing desired by the occupant of the vehicle 10 to improve the degree of freedom of the update.

The update apparatus 1 according to the present embodiment is configured so that the occupant of the vehicle 10 is capable of selecting one update from the multiple update options. Accordingly, in the update apparatus 1 according to the present embodiment, it is possible to perform the update of the content desired by the occupant of the vehicle 10 to improve the degree of freedom of the update.

In the update apparatus 1 according to the present embodiment, the presentation corresponding to the selected update is performed before the update is performed to notify the occupant of the vehicle 10 of the presentation. Accordingly, in the update apparatus 1 according to the present embodiment, the occupant of the vehicle 10 is capable of confirming whether the update is performed in the manner desired by the occupant of the vehicle 10 before the update is performed. Consequently, in the update apparatus 1 according to the present embodiment, it is possible to set the characteristics of the vehicle 10, which are desired by the occupant of the vehicle 10.

The update apparatus 1 according to the present embodiment is configured so that at least part of the parameters indicating the characteristics of the vehicle 10, which are identified by the selected update, is capable of being modified by the occupant of the vehicle 10. Accordingly, in the update apparatus 1 according to the present embodiment, it is possible to perform the update of the content desired by the occupant of the vehicle 10 to further improve the degree of freedom of the update.

In the update apparatus 1 according to the present embodiment, the presentation which corresponds to the selected update and the parameter of which is modified is performed before the update is performed to notify the occupant of the vehicle 10 of the presentation. Accordingly, in the update apparatus 1 according to the present embodiment, the occupant of the vehicle 10 is capable of confirming whether the parameter is modified in the manner desired by the occupant of the vehicle 10 before the update is performed. Consequently, in the update apparatus 1 according to the present embodiment, it is possible to set the characteristics of the vehicle 10, which are desired by the occupant of the vehicle 10.

In the update apparatus 1 according to the present embodiment, the specific structure 20 that is built so as to surround the vehicle 10 entering the specific area 80 is provided. In the update apparatus 1 according to the present embodiment, the notification unit 28 includes the display 90. The display 90 is provided at a position which is on an inner side opposed to the vehicle 10 of the specific structure 20 and at which the occupant of the vehicle 10 is capable of visually recognizing the screen of the display 90 from the inside of the vehicle 10 and visually notifies the display representing the presentation. Accordingly, in the update apparatus 1 according to the present embodiment, it is possible to improve the effect of the presentation to improve the motivation for the update.

In the update apparatus 1 according to the present embodiment, the notification unit 28 includes the speaker 92. The speaker 92 is provided at a position which is outside the vehicle 10 entering the specific area 80 and at which the occupant of the vehicle 10 is capable of hearing a sound from the speaker 92 from the inside of the vehicle 10 and auditorily notifies the occupant of the vehicle 10 of the sound representing the presentation. Accordingly, in the update apparatus 1 according to the present embodiment, it is possible to improve the effect of the presentation to improve the motivation for the update.

While the embodiments of the disclosure have been described with reference to the drawings, the disclosure is not limited to the embodiments. Those skilled in the art will recognize that the disclosure can be practiced with various modifications or changes in the spirit and scope of the appended claims and the modifications and changes are included in the technical scope of the disclosure.

For example, the update information in the above embodiments may include expiration period information indicating the expiration period during which the update is effective since the update has been performed. In this aspect, the vehicle controller 70 restores the characteristics of the vehicle 10 to the characteristics before the update is performed based on the restoring information when the vehicle 10 is in the ready-off state after the expiration period indicated by the expiration period information elapses. In this aspect, since the expiration period is set for the update, the element of attraction can be included in the update to improve the degree of freedom of the update.

According to the disclosure, it is possible to improve the motivation for update.

The control unit 32 and the vehicle control unit 56 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control unit 32 including the one or more processors 100, the update processor 110, and the one or more memories 102 and the vehicle control unit 56 including the vehicle processor 60, the vehicle controller 70, and the vehicle memory 62. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. An update apparatus comprising:
a vehicle detection unit configured to detect entrance of a vehicle into a specific area which the vehicle can enter;
a control unit;
a notification unit; and
a communication unit configured to establish communication between the control unit and the vehicle,
wherein the control unit comprises
at least one processor, and
at least one memory connected to the at least one processor, and
wherein the at least one processor performs a process comprising
performing, in response to detection of the entrance of the vehicle into the specific area, certain presentation indicating characteristics of the vehicle after update to update at least part of data and programs concerning control of the vehicle is performed, to perform a notification of the presentation to an occupant of the vehicle via the notification unit, and
performing a transmission of update information indicating content of the update to the vehicle via the communication unit after the presentation is indicated to cause the vehicle to perform the update.

2. The update apparatus according to claim 1,
wherein update options having different characteristics of the vehicle are prepared,
wherein the presentation and the update information are prepared for each of the update options,
wherein the at least one processor performs a process comprising causing the occupant of the vehicle to select one update from the update options,
wherein, in the notification of the presentation, the presentation corresponding to the selected update is performed to indicate the presentation via the notification unit, and
wherein, in the transmission of the update information, the update information corresponding to the selected update is transmitted to perform the selected update in the vehicle.

3. The update apparatus according to claim 2,
wherein the at least one processor performs a process comprising enabling the occupant of the vehicle to modify at least part of parameters indicating the characteristics of the vehicle, which are identified by the selected update,
wherein, in the notification of the presentation, the presentation which corresponds to the selected update and in which the modification of the parameter by the occupant of the vehicle is reflected is performed to indicate the presentation via the notification unit, and
wherein, in the transmission of the update information, the update information which corresponds to the selected update and in which the modification of the parameter by the occupant of the vehicle is reflected is transmitted to perform the selected update in which the modification of the parameter by the occupant of the vehicle is reflected in the vehicle.

4. The update apparatus according to claim 1, further comprising:
a specific structure configured to be built so as to surround the vehicle when the vehicle enters the specific area,
wherein the notification unit comprises a display that is provided at a position which is on an inner side opposed to the vehicle of the specific structure and at which the occupant of the vehicle is capable of visually recognizing a screen of the display from an inside of the vehicle, the display being configured to visually notify a display representing the presentation.

5. The update apparatus according to claim 1,
wherein the notification unit comprises a speaker that is provided at a position which is outside the vehicle entering the specific area and at which the occupant of the vehicle is capable of hearing a sound from an inside of the vehicle, the speaker being configured to auditorily notify a sound representing the presentation.

6. An update apparatus comprising
at least one processor, and
at least one memory connected to the at least one processor, wherein
the at least one processor is configured to
detect entrance of a vehicle into a specific area which the vehicle can enter, and
cause a communication unit to establish communication with the vehicle,
wherein the at least one processor performs a process comprising
performing, in response to detection of the entrance of the vehicle into the specific area, certain presentation indicating characteristics of the vehicle after update to update at least part of data and programs concerning control of the vehicle is performed, to notify an occupant of the vehicle of the presentation via a notification unit, and
transmitting update information indicating content of the update to the vehicle via the communication unit after the presentation is indicated to cause the vehicle to perform the update.
